(19) United States
(12) Patent Application Publication
(10) Pub. No.: US 2023/0322126 A1
(43) Pub. Date: Oct. 12, 2023

(54) CHEMICAL HEAT STORAGE DEVICE

(71) Applicant: HONDA MOTOR CO., LTD., Tokyo (JP)

(72) Inventors: Mitsumasa SORAZAWA, Saitama (JP); Hideki MATSUDA, Saitama (JP); Shoji TAKAHASHI, Saitama (JP); Takayuki SAKATA, Saitama (JP); Yushi FUJINAGA, Saitama (JP)

(21) Appl. No.: 18/190,045

(22) Filed: Mar. 24, 2023

(30) Foreign Application Priority Data
Mar. 31, 2022 (JP) 2022-060213

(51) Int. Cl. B05B 1/10; B60L 58/26; C09K 5/10; B60L 58/27

(52) U.S. Cl. CPC B60L 58/27; B05B 1/10; B60L 58/26; C09K 5/10; B60L 2240/545

(57) ABSTRACT

To adsorb an adsorbate rapidly on a heat storage material with good energy efficiency. A chemical heat storage device includes an adsorbate, a heat storage material, and a sprayer. The adsorbate is in a liquid state at normal temperature. The heat storage material releases heat of adsorption in response to adsorption of the adsorbate on the heat storage material and stores the heat of adsorption in response to desorption of the adsorbate from the heat storage material. The sprayer sprays the adsorbate on the heat storage material in a heat release period of causing the heat storage material to release the heat of adsorption. With the above-described configuration, it is possible to increase a speed of diffusion of the adsorbate in the heat storage material through spraying of the adsorbate on the heat storage material.

This application is based on and claims the benefit of priority from Japanese Patent Application No. 2022-060213, filed on 31 Mar. 2022, the content of which is incorporated herein by reference.

### BACKGROUND OF THE INVENTION

### Field of the Invention

The present invention relates to a chemical heat storage device storing heat of adsorption.

### Related Art

In recent years, electric-powered vehicles, such as electric vehicles (EVs) and hybrid electric vehicles (HEVs), have become popular for the purpose of reducing carbon dioxide emissions and thus reducing its adverse impact on the global environment. The electric-powered vehicles are equipped with batteries such as lithium-ion batteries.

Patent Document 1: Japanese Unexamined Patent Application, Publication No. 2022-039705

### SUMMARY OF THE INVENTION

In general, excessively high temperatures cause batteries to discharge and degrade faster. On the other hand, excessively low temperatures cause batteries to lose their ability to output sufficient voltage. This means that it is important to control the temperature of batteries.

The inventors have conceived the idea of using heat storage materials, such as MOF, etc. to control the temperature of batteries. Specifically, for example, when a battery has a high temperature, an adsorbate such as water, etc. adsorbed on a heat storage material is desorbed from the heat storage material by heat of the battery to thereby store heat of adsorption as latent heat in the heat storage material and cool the battery by heat absorption during this process. On the other hand, when the battery has a low temperature, an adsorbate is adsorbed on the heat storage material to thereby release heat of adsorption from the heat storage material and warm the battery by heat generation during the process.

To complete the warming in a short time, the adsorbate is required to be adsorbed rapidly on the heat storage material. Meanwhile, however, if heat is applied to the adsorbate, for example, to evaporate the adsorbate so that the adsorbate easily adsorbs on the heat storage material, evaporation heat is required to result in bad energy efficiency. Additionally, as a speed of supplying the adsorbate having a saturated vapor pressure is limited due to condensation, it is impossible to urge many adsorption reactions in a short time.

The present invention has been made in view of the above-described circumstances, and is intended to make a heat storage material adsorb an adsorbate rapidly with good energy efficiency.

The present inventors have focused attention on the point that spraying the adsorbate on the heat storage material using a sprayer enables the heat storage material to adsorb the adsorbate rapidly with good energy efficiency, thereby achieving the present invention. The present invention is intended for a chemical heat storage device having configurations (1) to (7) described below.

(1) A chemical heat storage device including: an adsorbate in a liquid state at normal temperature; a heat storage material that releases heat of adsorption in response to adsorption of the adsorbate on the heat storage material and stores the heat of adsorption in response to desorption of the adsorbate from the heat storage material; and a sprayer that sprays the adsorbate on the heat storage material during a heat release period of causing the heat storage material to release the heat of adsorption.

With this configuration, it is possible to increase a speed of diffusion of the adsorbate in the heat storage material through spraying of the adsorbate on the heat storage material. This allows the adsorbate to be adsorbed rapidly on the heat storage material. Moreover, this achieves good energy efficiency, compared to a case of applying heat to the adsorbate to evaporate the adsorbate. As a result, with this configuration, the heat storage material can adsorb the adsorbate rapidly thereon with good energy efficiency.

(2) The chemical heat storage device according to (1) described above, including: a container storing the heat storage material; and a controller that controls the amount of the adsorbate present in the container.

With this configuration, controlling the amount of the adsorbate present in the container facilitates supply of the adsorbate to the heat storage material without excess or deficiency.

(3) The chemical heat storage device according to (2) described above, wherein during the heat release period, the controller controls the amount of the adsorbate present in the container from 100 to 400% relative to a saturated adsorption amount of the adsorbate by the entire heat storage material stored in the container.

With this configuration, by controlling the amount of the adsorbate equal to or greater than 100% relative to the saturated adsorption amount, the adsorbate is adsorbed rapidly on the heat storage material to allow the heat of adsorption to be released rapidly. Furthermore, controlling the amount of the adsorbate equal to or less than 400% relative to the saturated adsorption amount limits the amount of the adsorbate to be sprayed superfluously, making it possible to suppress increase in heat capacity caused by the superfluous adsorbate. As a result, with this configuration, heat can be generated rapidly at the heat storage material by causing the heat storage material to release the heat of adsorption rapidly and suppressing increase in heat capacity.

(4) The chemical heat storage device according to any one of (1) to (3) described above, wherein the adsorbate sprayed by the sprayer has an average particle diameter from 1 to 200 µm.

With this configuration, the particle diameter of the adsorbate of equal to or less than 200 um causes the adsorbate to diffuse easily in the heat storage material. Furthermore, the particle diameter of the adsorbate of equal to or greater than 1 um can reduce output of a pump, etc. for supplying pressure to the sprayer, or required resistance to pressure of the sprayer, etc.

(5) The chemical heat storage device according to any one of (1) to (4) described above, wherein the sprayer sprays a total spraying amount to be sprayed during the heat release period, separately in multiple stages, and one spraying cycle in the spraying in the multiple stages is equal to or less than 1 second.

The sprayer sprays the total spraying amount separately in multiple stages. This causes the adsorbate to diffuse easily in the heat storage material compared to a case of spraying the total spraying amount once. Moreover, one spraying cycle of equal to or less than 1 second can suppress adverse effects that heat generated by adsorption cools down during the course of a spraying cycle and a speed of heat generation at the heat storage material is reduced. The multi-stage spraying described above causes the adsorbate to diffuse more rapidly in the heat storage material and reduces the occurrence of an adverse effect that generated heat cools down during the course of a spraying cycle, making it possible to generate heat more rapidly at the heat storage material.

(6) The chemical heat storage device according to any one of (1) to (5) described above, including: a tank that stores the adsorbate and a pump that applies pressure to inside of the tank, in which the pump applies pressure to the inside of the tank before the heat release period, and the sprayer sprays the adsorbate during the heat release period using the pressure in the tank.

With this configuration, pressure is applied to the inside of the tank before the heat release period and the adsorbate is sprayed using the pressure in the tank during the heat release period. This makes it possible to reduce time loss before spraying during the heat release period and reduce energy consumption during the heat release period. Furthermore, as pressure is applied before the heat release period, a maximum output of the pump can be reduced compared to a case of applying pressure quickly during the heat release period. This also leads to size reduction of the pump.

(7) The chemical heat storage device according to any one of (1) to (6) described above, wherein the chemical heat storage device is mounted on a movable body, and the chemical heat storage device controls a temperature at a battery that supplies electric power to a drive device for moving the movable body.

The chemical heat storage device is mounted on the movable body. Thus, if gases such as carbon dioxide and methane are employed as the adsorbate, for example, such gases are required to be stored as high-pressure gases in the movable body. In this regard, as the adsorbate is in a liquid state at normal temperature in the configuration in (1) described above on which this configuration depends, this adsorbate is not required to be stored as a high-pressure gas. This provides good usability in mounting the chemical heat storage device on the movable body.

As described above, with the configuration in (1) described above, the heat storage material can adsorb the adsorbate rapidly thereon with good energy efficiency. Furthermore, the aspects (2) to (7) described above depending on (1) described above achieve respective additional effects.

### BRIEF DESCRIPTION OF THE DRAWINGS

FIG. 1 is a schematic view showing a chemical heat storage device according to a present embodiment;

FIG. 2 is a schematic view showing the chemical heat storage device in a heat storage period;

FIG. 3 is a conceptual view showing a heat storage material in the heat storage period;

FIG. 4 is a graph showing a relationship between the relative pressure of water as an adsorbate and a water adsorption amount;

FIG. 5 is a schematic view showing the chemical heat storage device in a heat release period;

FIG. 6 is a conceptual view showing the heat storage material during the heat release period;

FIG. 7 is a graph showing temperature transition at the heat storage material observed in each of the presence and absence of spraying;

FIG. 8 is a graph showing temperature transition at the heat storage material after spraying observed in each spraying duration;

FIG. 9 is a graph showing a relationship between a spraying ratio of water and a maximum increased temperature;

FIG. 10 is a graph showing temperature transition observed in each spraying frequency; and

FIG. 11 is a graph showing temperature transition observed in each length of a spraying cycle.

### DETAILED DESCRIPTION OF THE INVENTION

An embodiment of the present invention will be described below by referring to the drawings. The present invention shall never be limited to the following embodiment but can be carried out by being modified within a range not deviating from the spirit of the invention.

### First Embodiment

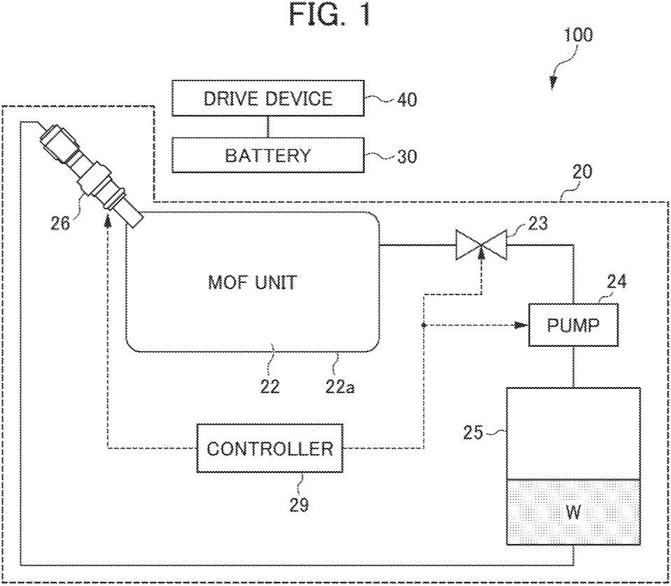

FIG. 1 is a schematic view showing a chemical heat storage device 20 according to the present embodiment. The chemical heat storage device 20 is mounted on an electrically-driven vehicle 100 such as an EV or an HEV. The electrically-driven vehicle 100 is equipped with a drive device 40 such as a motor that causes the electrically-driven vehicle to travel, and a battery 30 that supplies electric power to the drive device 40. The battery 30 is a lithium-ion battery having a liquid electrolyte, for example.

The chemical heat storage device 20 is provided for the battery 30, and cools and warms the battery 30 through heat exchange with the battery 30. The chemical heat storage device 20 includes an MOF unit 22, a collection valve 23, a pump 24, a tank 25, a sprayer 26, and a controller 29.

The MOF unit 22 includes an MOF, specifically, a metal-organic framework, and a container 22a storing the MOF. The MOF is MIL-101 and has a pore structure. With this pore structure, the MOF is configured to allow molecules such as water molecules to be adsorbed in large quantity.

An inlet of the pump 24 is connected to the container 22a through the collection valve 23. An outlet of the pump 24 is connected to the sprayer 26 through the tank 25.

The sprayer 26 is mounted on the container 22a and is configured to be capable of spraying water W, as an adsorbate to be adsorbed on the MOF, to the MOF. The sprayer 26 of the present embodiment is an injector for gasoline injection developed by the present applicant and others, and is prepared by changing its purpose of use to water spraying. The sprayer 26 further functions as a water W supply valve for the MOF. When the sprayer 26 is off, the supply valve is closed. When the sprayer 26 is on, the supply valve is opened.

With the above-described configuration, the chemical heat storage device 20 seals the water W while allowing the water W to circulate between the container 22a and the tank 25 in a manner not contacting the battery 30.

The controller 29 controls the amount of the water W present in the container 22a by controlling the collection valve 23, the pump 24, and the sprayer 26.

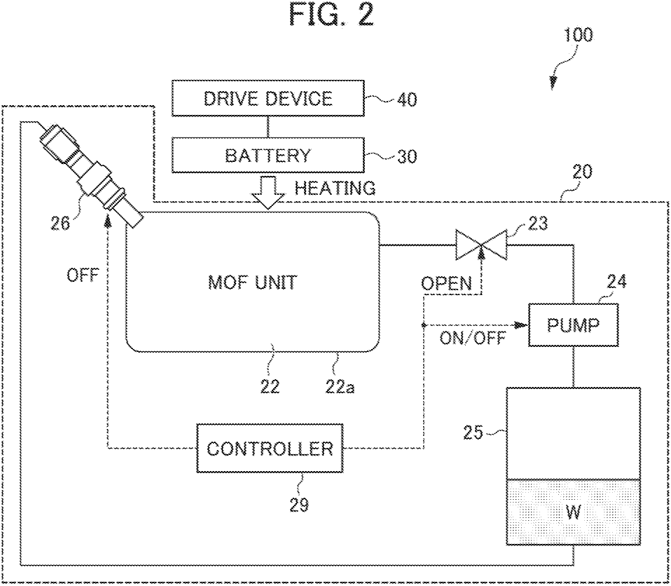

FIG. 2 is a schematic view showing the chemical heat storage device 20 in a heat storage period of storing heat of adsorption as latent heat in the MOF. In the heat storage period, the controller 29 opens the collection valve 23 and turns off the sprayer 26. At this time, to facilitate release of the water W from the MOF, basically a negative-pressure state where the pressure is lower than atmospheric pressure is generated in the container 22a. To achieve this, the pressure in the container 22a is reduced by turning the pump 24 on as needed.

In this negative-pressure state, when the MOF is heated with the heat of the battery 30, the water W is desorbed from the MOF. By doing so, the heat of adsorption is stored as latent heat in the MOF, and the battery 30 is cooled with resultant heat absorption. The water W desorbed from the MOF is collected in the tank 25 through the collection valve 23 and the pump 24.

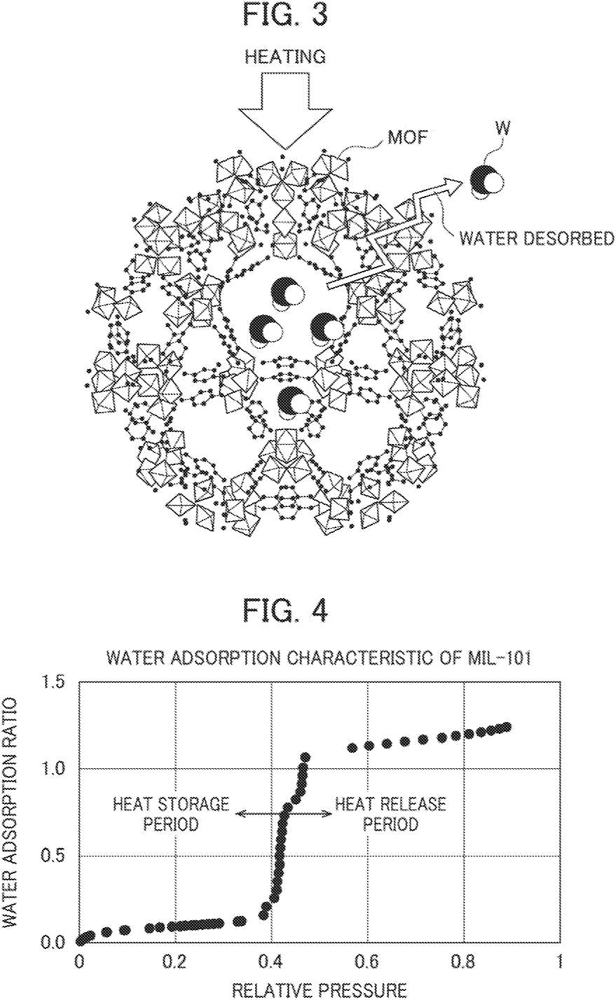

FIG. 3 is a conceptual view showing the MOF in the heat storage period. As described above, the water W adsorbed on the MOF having the pore structure is desorbed from the MOF through absorption of the heat of the battery 30. By doing so, the heat of adsorption is stored in the MOF, and the battery 30 is cooled, as described above.

FIG. 4 is a graph showing a relationship between the relative pressure of water and a water adsorption ratio. The “relative pressure of water” mentioned herein means a ratio of water vapor pressure to pressure in the container 22a. Also, the “water adsorption ratio” means a ratio of a saturated adsorption weight of water molecules adsorbed on the MOF to the weight of the MOF.

As the relative pressure of water is reduced, the water adsorption ratio drops steeply at a relative pressure around 0.4 as a boundary. For this reason, in the heat storage period, the controller 29 controls in such a manner as to make the relative pressure of the water W in the container 22a lower than the boundary to facilitate desorbing of the water W from the MOF. On the other hand, in a heat release period described later, the controller 29 controls in such a manner as to make the relative pressure of the water in the container 22a higher than the boundary to facilitate adsorbing of the water W on the MOF.

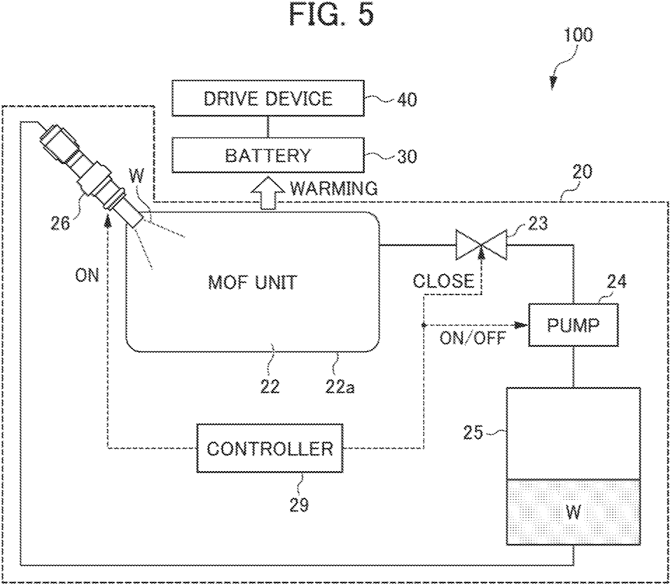

FIG. 5 is a schematic view showing the chemical heat storage device 20 during the heat release period of causing the MOF to release the heat of adsorption. If the controller 29 detects the necessity of warming the battery 30 in response to temperature reduction at the battery 30, for example, the controller 29 closes the collection valve 23, turns the pump 24 on before the heat release period, and thereby applies pressure to the inside of the tank 25. By doing so, a high pressure is generated in the tank 25. At this time, the pressure in the tank 25 is equal to or less than about 5 atmospheres, for example.

In the subsequent heat release period, the controller 29 turns the sprayer 26 on while keeping the collection valve 23 closed. By doing so, the water W is sprayed from the sprayer 26 toward the MOF by using the pressure in the tank 25. The sprayed water W has an average particle diameter from 1 to 200 µm. At this time, output of the pump 24 or turning on and off of the pump 24 is controlled in response to excess or deficiency of the pressure in the tank 25. Spraying the water W makes the relative pressure of water in the container 22a higher than the boundary described above. The sprayed water W is adsorbed on the MOF, thereby the heat of adsorption is released from the MOF, and the battery 30 is warmed by resultant heat generation.

In the following, the ratio of the amount of the water W present in the container 22a to the saturated adsorption amount of water molecules by the entire MOF stored in the container 22a is called a “spraying ratio”. The “saturated adsorption amount” and the “amount of the water W” mentioned herein are each determined by weight. During the heat release period, if the amount of required heat is small, the controller 29 controls the spraying ratio less than 100%. On the other hand, if the amount of required heat is large, the controller 29 controls the spraying ratio within the range of 100 to 400%. A reason for this will be described later. Furthermore, the controller 29 sprays a total spraying amount separately in multiple stages. One spraying cycle is equal to or less than 1 second. Reasons for these will also be described later.

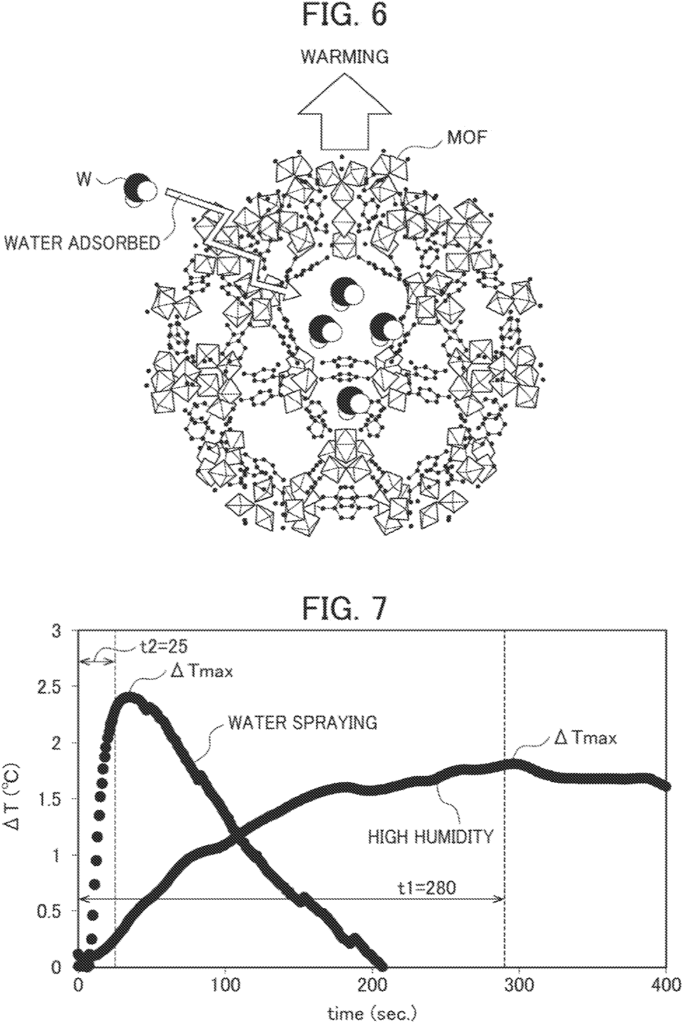

FIG. 6 is a conceptual view showing the MOF during the heat release period. The water W is adsorbed on the MOF having the pore structure. By doing so, the heat of adsorption is released from the MOF and the battery 30 is warmed, as described above.

The following describes a reason for spraying the water W on the MOF using the sprayer 26 while referring to FIG. 7.

FIG. 7 is a graph showing a difference in temperature increase at the MOF between a case where the MOF is introduced into a room at a humidity of 95% and a case where the water is sprayed on the MOF using the sprayer. The MOF used here is MIL-101 in a dried state. During the spraying, the water has a particle diameter of about 100 µm. The graph has a vertical axis showing an increased temperature ΔT and a horizontal axis showing elapsed time. In the following, the increased temperature ΔT at a point where the increased temperature ΔT is at its maximum is called a “maximum increased temperature ΔTmax”, and elapsed time at the point of the maximum increased temperature ΔTmax is called “maximum temperature reaching time”.

Maximum temperature reaching time t1 in the case of introduction of the MOF into the room at a humidity of 95% is about 280 seconds. Meanwhile, maximum temperature reaching time t2 in the case of spraying of water on the MOF using the sprayer is about 25 seconds. Specifically, it was confirmed that a response speed was improved about 10 times by the spraying of the water.

On the basis of the foregoing result, the configuration of spraying the water W on the MOF using the sprayer 26 is employed in the present embodiment, as described above.

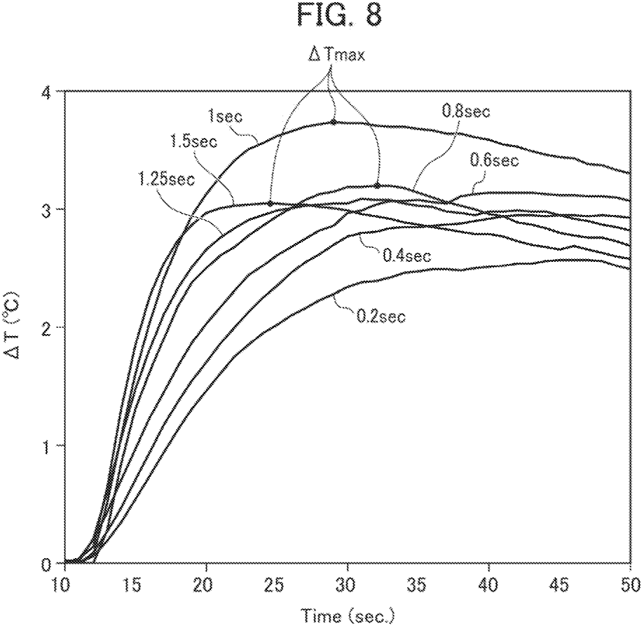

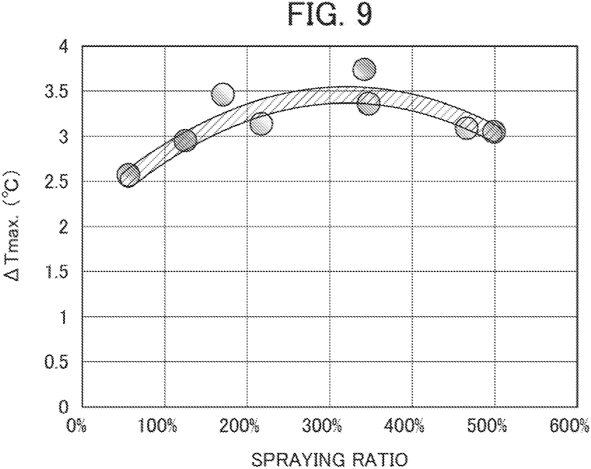

The following describes a reason for controlling the spraying ratio within the range of 100 to 400% in response to a large amount of required heat by referring to FIGS. 8 and 9.

FIG. 8 is a graph showing temperature transition at the MOF after spraying observed in each duration of spraying of water using the sprayer. A horizontal axis shows elapsed time after spraying, and a vertical axis shows the increased temperature ΔT at the MOF. Curves correspond to respective cases where spraying durations are 0.2 seconds, 0.4 seconds, 0.6 seconds, 0.8 seconds, 1 second, 1.25 seconds, and 1.5 seconds. A longer spraying duration results in a larger amount of the sprayed water W to increase the spraying ratio.

FIG. 9 is a graph showing a relationship between the spraying ratio of water on the MOF and the maximum increased temperature ΔTmax. A maximum adsorption amount of water molecules by the MOF, namely, the saturated adsorption amount is determined on the basis of the type of the MOF. Here, the MOF is MIL-101 having a thickness of about 2 mm. Using the MOF under such a condition result in the saturated adsorption amount of water molecules of 130% by weight of the MOF. Thus, when exceeding this value, it is considered that temperature increase at the MOF is suppressed, as a result of the heat capacity of water supplied superfluously.

However, this test shows that, with the spraying ratio of about 350%, greatly exceeding 130%, the maximum increased temperature ΔTmax reaches its peak. In other words, it was confirmed that when spraying the water W superfluously, the maximum increased temperature ΔTmax reaches its peak. A possible reason for this is that supplying superfluous water increases a speed of diffusion of water in a thickness direction of the MOF, release much heat of adsorption in a short time, and leads to improvement of temperature increase. If the spraying ratio exceeds 350%, however, it is considered that the action of suppressing temperature increase as a result of increase in heat capacity surpasses this improvement effect as may be expected, leading to reduction in the maximum increased temperature ΔTmax.

On the basis of the foregoing result, the controller 29 controls the spraying ratio within the range of 100 to 400% in response to a large amount of required heat, as described above.

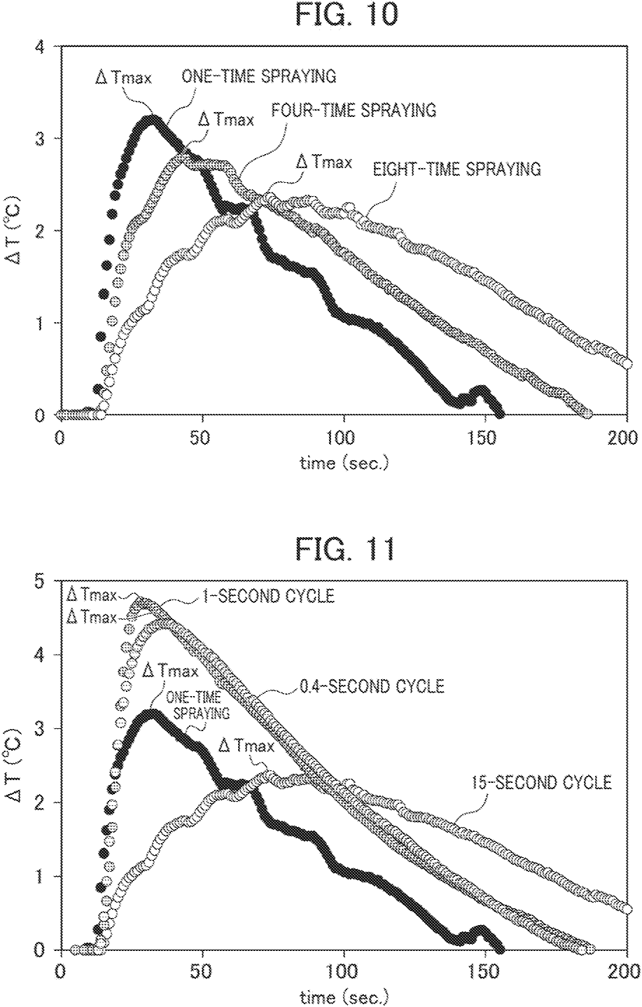

The following describes a reason for spraying a total spraying amount separately in multiple stages and a reason for setting one spraying cycle equal to or less than 1 second by referring to FIGS. 10 and 11.

FIG. 10 shows result of test conducted by changing a spraying frequency while a total amount of water to be sprayed by the sprayer is constant. More specifically, FIG. 10 is a graph showing transition of the increased temperature ΔT at the MOF in each of three types of spraying frequency including once, four times, and eight times. In each of these three cases, a spraying cycle from start of one spraying to start of next spraying is 15 seconds.

As understood from this graph, it was confirmed that increasing a spraying frequency further, namely, spraying more separately, the maximum increased temperature ΔTmax reduces to a greater degree. A possible reason for this is that heat generated at the MOF cools down during the course of a spraying cycle. Specifically, the following are considered: the energy of heat generated by each stage spraying dissipates before next stage spraying; therefore, on the energy of heat generated by each stage spraying, the energy of heat generated by next stage spraying does not superimpose efficiently; thus the temperature increase slows down. In response to this, shortening a spraying cycle was considered.

FIG. 11 shows result of test conducted by changing the duration of one spraying cycle while a spraying amount and a spraying frequency are constant. This test was conducted by spraying eight times in each of three types of cycles including a 15-second cycle, a 1-second cycle, and a 0.4-second cycle. A graph in FIG. 11 shows transition of the increased temperature ΔT at the MOF in each of these three cases. This graph further shows a case where the same spraying amount was sprayed once.

In the case of the 15-second cycle, the maximum increased temperature ΔTmax was lower than that in the case of the one-time spraying. By contrast, in each of the cases of the 1-second cycle and the 0.4-second cycle, namely, in the case of a cycle of equal to or greater than 1 Hz, the maximum increased temperature ΔTmax was increased by about 50% compared to that in the case of the one-time spraying. A possible reason for this is that spraying intensively in a short time made it possible to ensure accumulation of generated heat and additionally, spraying intermittently increased a spraying speed to cause improved water diffusion into the MOF.

On the basis of the foregoing result, the controller 29 sprays a total spraying amount separately in multiple stages and sets one spraying cycle equal to or less than 1 second, as described above. A frequency of spraying by the sprayer 26 is not particularly limited. If the frequency is too low, however, sufficient effect cannot be expected. For this reason, the frequency is preferably equal to or greater than four times, more preferably, equal to or greater than five times, still more preferably, equal to or greater than six times. Meanwhile, a too high frequency increases burden of such as control. For this reason, the frequency is preferably equal to or less than 50 times, more preferably, equal to or less than 40 times, still more preferably, equal to or less than 30 times.

The configuration and effects of the present embodiment are outlined as follows.

The sprayer 26 sprays the water W to the MOF during the heat release period of causing the MOF to release the heat of adsorption. This makes it possible to increase a speed of diffusion of the water W in the MOF to allow the water W to be adsorbed rapidly on the MOF. Moreover, compared to a case of applying heat to the water W to evaporate the water W, evaporation heat is not required, so that good energy efficiency is provided. As a result, according to the present embodiment, the water W can be rapidly adsorbed on the MOF with good energy efficiency.

The controller 29 controls the amount of the water W present in the container 22a. This facilitates supply of the water W to the MOF without excess or deficiency.

The controller 29 controls the spraying ratio equal to or greater than 100% during the heat release period. By doing so, the water W can be adsorbed rapidly on the MOF, and the heat of adsorption can be released rapidly. Furthermore, the controller 29 controls the spraying ratio equal to or less than 400% during the heat release period. By doing so, the amount of the water W to be sprayed superfluously can be limited, and increase in heat capacity caused by the water W can be suppressed. As a result, heat can be generated rapidly at the MOF by releasing the heat of adsorption rapidly and suppressing increase in heat capacity.

The sprayed water W has a particle diameter of equal to or less than 200 µm. This causes the water W to diffuse easily in the MOF. The water W has a particle diameter of equal to or greater than 1 um. This can reduce pressure burden on the pump 24 and required resistance to pressure for such as the tank 25 and the sprayer 26.

The sprayer 26 sprays a total spraying amount separately in multiple stages. This causes the water W to diffuse easily in the MOF compared to a case of spraying the total spraying amount once. Moreover, one spraying cycle of equal to or less than 1 second can reduce the adverse effect that heat generated by adsorption of water cools down during the course of a spraying cycle and a speed of heat generation at the MOF is reduced. The multi-stage spraying described above causes the water W to diffuse more rapidly in the MOF and reduces the adverse effect that generated heat cools down during the course of a spraying cycle, so that it makes possible to generate heat more rapidly at the MOF.

Pressure is applied to inside of the tank 25 before the heat release period and the water W is sprayed by the pressure in the tank 25 during the heat release period. This makes it possible to reduce time to be lost until spraying during the heat release period and energy consumption during the heat release period. Furthermore, as pressure is applied before the heat release period, a maximum output of the pump 24 can be reduced compared to a case of applying pressure quickly during the heat release period. This leads to size reduction of the pump 24.

The chemical heat storage device 20 is mounted on the electrically-driven vehicle 100. Thus, if gases such as carbon dioxide and methane are employed, for example, as an adsorbate to be adsorbed on the MOF instead of the water W, such gases are required to be stored as high-pressure gases in the electrically-driven vehicle 100. In this regard, in the present embodiment, as the adsorbate is the water W that is in a liquid state at normal temperature, it is not required to be stored as a high-pressure gas. This provides good usability in mounting the chemical heat storage device 20 on the electrically-driven vehicle 100.

### Modified Embodiments

The above-described embodiment can be carried out by being modified as follows, for example. The MOF may be changed to a heat storage material other than an MOF such as silica gel, zeolite, or activated carbon. An adsorbate to be adsorbed on the heat storage material such as an MOF may be changed to a substance other than water such as ethanol that is in a liquid state at normal temperature.

The chemical heat storage device 20 and the battery 30 may be mounted on a movable body other than the electrically-driven vehicle 100 such as a ship or a drone, for example, or may be mounted on a fixed body. Furthermore, the chemical heat storage device 20 may be provided for objects other than the battery 30 such as various types of circuits that generate a large amount of heat.

### EXPLANATION OF REFERENCE NUMERALS

20 Chemical heat storage device
22a Container
24 Pump
25 Tank
26 Sprayer
29 Controller
30 Battery
40 Drive device
100 Electrically-driven vehicle as movable body
MOF MOF as heat storage material
W Water as adsorbate

What is claimed is:

1. A chemical heat storage device comprising: an adsorbate in a liquid state at normal temperature;
a heat storage material that releases heat of adsorption in response to adsorption of the adsorbate on the heat storage material and stores the heat of adsorption in response to desorption of the adsorbate from the heat storage material; and
a sprayer that sprays the adsorbate on the heat storage material during a heat release period of causing the heat storage material to release the heat of adsorption.

2. The chemical heat storage device according to claim 1, comprising: a container storing the heat storage material; and
a controller that controls an amount of the adsorbate present in the container.

3. The chemical heat storage device according to claim 2, wherein during the heat release period, the controller controls an amount of the adsorbate present in the container from 100 to 400% relative to a saturated adsorption amount of the adsorbate by the entire heat storage material stored in the container.

4. The chemical heat storage device according to claim 1, wherein the adsorbate sprayed by the sprayer has an average particle diameter from 1 to 200 µm.

5. The chemical heat storage device according to claim 1, wherein the sprayer sprays a total spraying amount to be sprayed during the heat release period, separately in multiple stages, and
one spraying cycle in the spraying in the multiple stages is equal to or less than 1 second.

6. The chemical heat storage device according to claim 1, comprising: a tank that stores the adsorbate and a pump that applies pressure to inside of the tank, wherein
the pump applies pressure to inside of the tank before the heat release period, and
the sprayer sprays the adsorbate during the heat release period using the pressure in the tank.

7. The chemical heat storage device according to claim 1, wherein the chemical heat storage device is mounted on a movable body, and
the chemical heat storage device controls a temperature at a battery that supplies electric power to a drive device for moving the movable body.
